(19) United States
(12) Patent Application Publication
(10) Pub. No.: US 2019/0270089 A1
(43) Pub. Date: Sep. 5, 2019

(54) METHOD FOR ACTUATING A MOTOR FOR STARTING A MILL

(71) Applicant: Siemens Aktiengesellschaft, München (DE)

(72) Inventor: Werner Kitz, Erlangen (DE)

(73) Assignee: Siemens Aktiengesellschaft, München (DE)

(21) Appl. No.: 16/320,237

(22) PCT Filed: Jul. 29, 2016
(86) PCT No.: PCT/EP2016/068182

§ 371 Date: Jan. 24, 2019

(51) Int. Cl. B02C 25/00; H02P 1/28; H02P 5/747

(52) U.S. Cl. CPC B02C 25/00; H02P 5/747; H02P 1/28

(57) ABSTRACT

In a method for actuating a motor for starting up a mill containing material to be ground, the motor for triggering sedimentation of the material to be ground in the mill is initially fed by a first inverter. The motor is subsequently disconnected from the first inverter, and in a further step the motor is connected to a first supply which has a first supply voltage. The maximum output voltage of the first inverter is lower than the first supply voltage.

The invention relates to a method for controlling a motor for starting a mill containing material to be ground.

The invention also relates to a control device for carrying out such a method.

In addition, the invention relates to a drive unit having at least one such control device.

The invention further relates to a mill arrangement having at least one such drive unit.

Mills, particularly vertical mills, are preferably used for grinding materials such as ore. Sometimes the operation of a mill at least partially charged with a material to be ground will be interrupted for a lengthy period of time and the mill will be at a standstill. This occurs e.g. for maintenance purposes. While the mill is at a standstill, the material to be ground in the mill may solidify. Such sedimentation of the material results in a very high starting torque. The electrical drives used must therefore be heavily overdesigned, particularly in respect of maximum torque at low speeds down to zero, which makes said electrical drives very expensive.

By slow movement e.g. of a stirrer, a spindle, a screw or some other tool, water released during sedimentation is returned to the material to be ground, the sedimentation is dispersed and the required starting torque is significantly reduced. Sedimentation can also be prevented by occasional slow rotation.

Patent specification EP 1 735 099 B1 discloses a method for detaching a charge adhering to the inner wall of a grinding tube of a tube mill, wherein the drive unit of the grinding tube is controlled by a control device for targeted removal of the adhering charge. The grinding tube is rotated in a targeted manner such that the repeated changing of the rotation speed of the grinding tube and possibly the abrupt deceleration of the grinding tube causes the adhering charge to be removed from the inner wall of the grinding tube.

Published unexamined patent application WO 2012/110358 A1 discloses a drive system for a ball mill driven by a wound-rotor motor, wherein the motor is assigned a set of at least two different characteristics setting the torque thereof in relation to another parameter. The drive system additionally has a switching element which abruptly switches the drive system between the two characteristics if the value of the parameter is constant.

The object of the invention is to provide more cost-efficient starting of a mill compared to the prior art.

This object is achieved according to the invention by a method for controlling a motor for starting a mill containing material to be ground, wherein, to disperse any sedimentation of the material to be ground in the mill, the motor is initially fed by a first converter, the motor is then disconnected from the first converter, and in a further step the motor is connected to a first supply which provides a first supply voltage and wherein the maximum output voltage of the first converter is lower than the first supply voltage.

The object is also achieved according to the invention by a control device for carrying out such a method.

The object is additionally achieved according to the invention by a drive unit having at least one such control device.

In addition, the object is achieved according to the invention by a mill arrangement having at least one such drive unit.

The advantages and preferred embodiments described below in respect of the method apply analogously to the control device, the drive unit and the mill arrangement.

The invention is based on the idea of using known physical relationships between torque and current and between speed and voltage to reduce the costs of starting up the mill. When grinding is in progress, the motor of the mill is operated from a first supply, in particular with constant frequency. For starting at higher torque, e.g. because of solidification of the charge, which is termed sedimentation, and at a lower speed, a first converter having a maximum output voltage which is lower than the first supply voltage of the first supply is used. Particularly after dispersal of the sedimentation in the mill, in particular at a defined speed, the first converter is disconnected from the motor. Once the sedimentation has been dispersed, the torque required for starting the mill is significantly lower. However, a higher speed is required for the further grinding process, which means that the motor requires a higher voltage. The motor is therefore connected to the first supply for further operation. For the same output current, such a first converter having a maximum output voltage that is lower than the first supply voltage of the first supply is more cost-effective than in particular a converter having a maximum output voltage on a par with the first supply voltage of the first supply. Moreover, with a first converter of this kind the supply system load is reduced due to the lower power consumption.

In a preferred embodiment, the maximum output voltage of the first converter is set at max. 50% of the first supply voltage of the first supply. The ratio of maximum output voltage of the first converter to the first supply voltage is dependent on the type and size of the mill arrangement and on the charge to be ground in the mill. A ratio of max. 50% results in a good cost position for the first converter and the speed is sufficiently high to remove the sedimentation.

The motor is preferably operated at a constant rated frequency while connected to the first supply, wherein the rated frequency is greater than the maximum output frequency of the first converter. Operation at a constant rated frequency, in particular directly from the first supply, is cost-effective, as no other converter is generally required for the grinding operation. For removal of the sedimentation it is sufficient that the speed, which is determined by the output frequency of the first converter, is lower than the in particular constant speed during the grinding operation. A first converter of this kind is cost-effective.

The maximum output frequency of the first converter is set at max. 30% of the rated frequency of the first supply. Such a maximum ratio between maximum output frequency of the first converter and rated frequency has been empirically found to be particularly advantageous.

With particular advantage, the first converter is operated from a second supply providing a second supply voltage. In particular, a second supply voltage of the second supply is lower than a first supply voltage of the first supply. For example, the second supply voltage is in the range of up to 1000 volts whereas the first supply voltage is in the range of up to 15,000 V. Operation of such a second supply with lower second supply voltage is efficient and inexpensive.

In a preferred embodiment, after disconnection from the first converter and prior to connection to the first supply, the motor is connected to a second converter whose maximum output voltage corresponds to the first supply voltage. Particularly if the supply system load is still too high after removal of the sedimentation using the first converter, the second converter is used to ramp up the motor on the supply to the frequency of the first supply. In particular, the second converter is designed for the motor rating with only slight overload and does not need to be specified for the high current required for removing the sedimentation of the material to be ground. Such a converter combined with the first converter is still less expensive than a single converter that is designed for the complete current range and voltage range, and can therefore be used both to remove the sedimentation and for conventional grinding operation.

The motor is preferably synchronized with the first supply by the second converter. In particular, the second converter matches the phase and/or the frequency of the output voltage to the first supply. Such synchronization enables the motor to be switched over to the first supply in a supply-friendly manner, i.e. without major discontinuities in the current and/or in the voltage, for example.

In a preferred embodiment, at least two motors each assigned to a mill are connected at least to the first converter in a time-offset manner. As the first converter is required in particular to remove a sedimented charge in a mill, it is cost-effective to make the first converter available to a plurality of mills in a time-offset manner.

A low-voltage converter is preferably used as the first converter. The maximum output voltage of the low-voltage converter is up to 1000 volts. This voltage range empirically constitutes the optimum of performance and cost-efficiency.

The low-voltage converter is advantageously operated from a low-voltage supply. Operating the low-voltage converter from a low-voltage supply is efficient and cost-effective.

In a preferred embodiment, a medium-voltage supply is used as the first supply. The medium-voltage supply has a maximum voltage in the range of up to 15,000 volts. Such a voltage range is advantageous for efficient power connection of an in particular vertical mill that is suitable e.g. for grinding ore.

In a preferred embodiment, a medium-voltage converter is used as the second converter. A medium-voltage converter is optimal for a medium-voltage supply.

The invention will now be described and explained in greater detail with reference to the exemplary embodiments illustrated in the accompanying drawings in which:

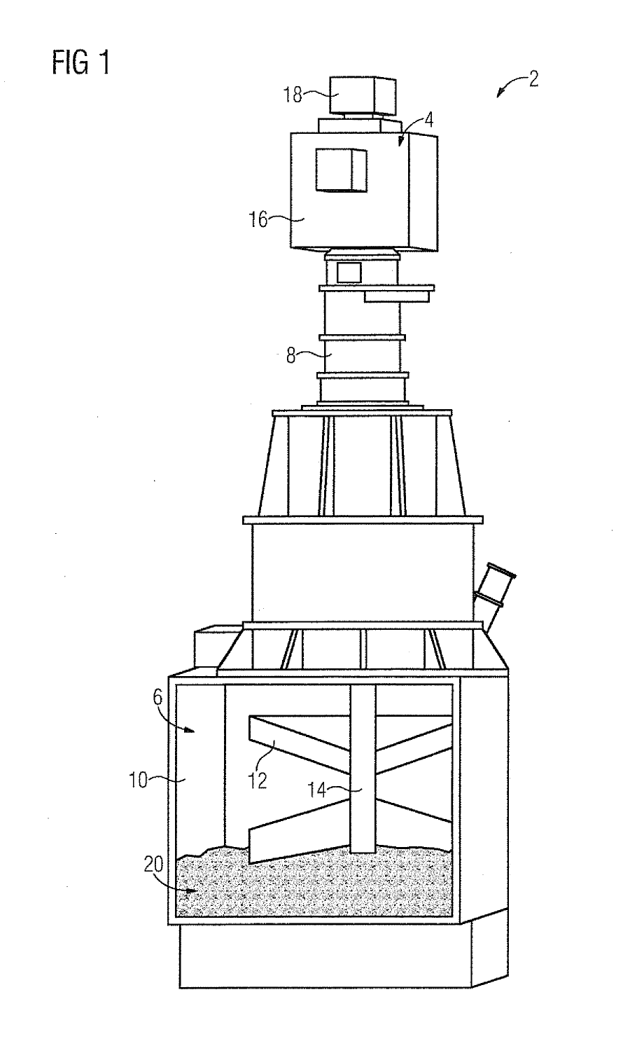

FIG. 1 shows a three-dimensional representation of a vertical mill arrangement,

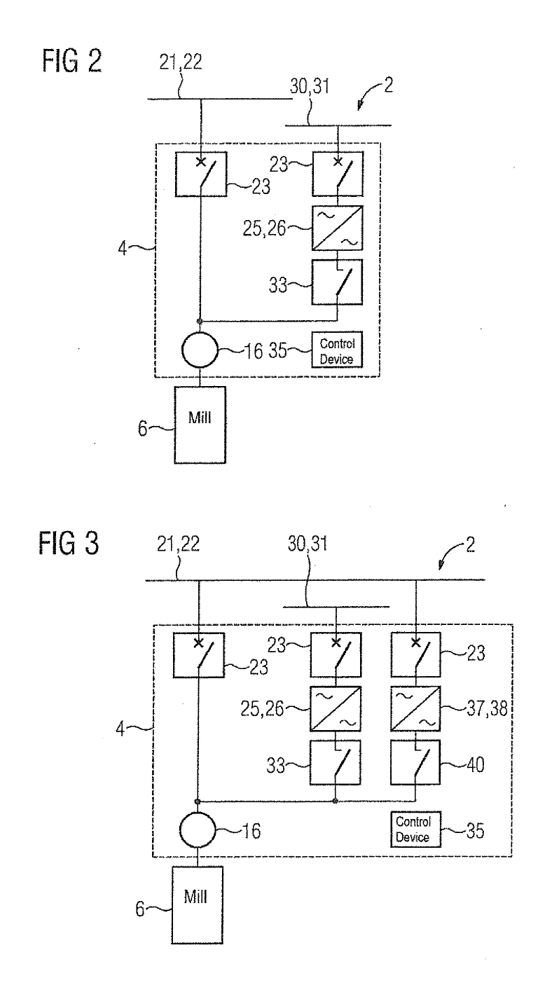

FIG. 2 shows a schematic layout of a first embodiment of a mill arrangement,

FIG. 3 shows a schematic layout of a second embodiment of a mill arrangement and

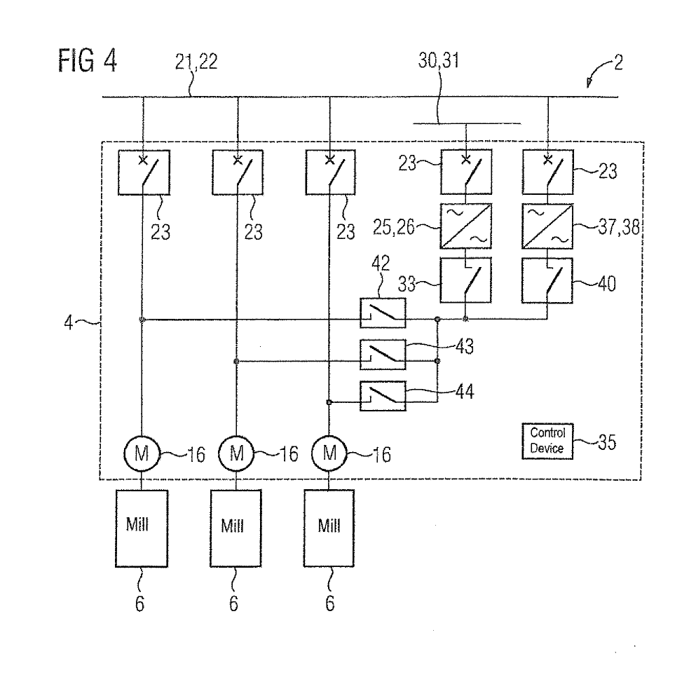

FIG. 4 shows a schematic layout of a third embodiment of a mill arrangement.

Identical reference characters have the same meaning in the different figures.

FIG. 1 shows a three-dimensional representation of a vertical mill arrangement 2 comprising a drive unit 4 and a mill 6. The drive unit 4 is mechanically connected to the mill 6 via a gearing 8. The mill 6 comprises a grinding cylinder 10 containing a grinding tool 12. The grinding tool 12 can be implemented as a stirrer, spindle, screw or in some other way and has a shaft 14 which is connected to the gearing 8. However, the shaft 14 of the grinding tool 12 can also be connected directly to a shaft of the drive unit 4, e.g. via a flanged joint. The shaft of drive unit 4, which is not shown in FIG. 1, is driven by a motor 16 which is preferably fed by a converter 18. The converter 18 can also be disposed at another location, e.g. in a separate room. The motor 16 is preferably designed as an asynchronous squirrel-cage motor that can be operated at a power of at least 100 kilowatts.

The grinding cylinder 10 contains material 20 to be ground, also termed the charge 20, to which a grinding motion is imparted by the grinding tool 12 by rotation of the shaft 14. If the operation of a mill 6 at least partially charged with material 20 to be ground is interrupted e.g. for maintenance purposes and the mill stands idle for a lengthy period time, the material 20 to be ground may solidify in the mill 6 during this downtime. Such sedimentation of the material 20 to be ground necessitates a very high starting torque which has to be produced by the motor 16.

For example, for mills 6 in which sedimentation of this kind is likely to occur, special asynchronous motors with squirrel-cage rotors and high starting torque or wound-rotor motors with increased starting torque are used. Although wound-rotor, motors require relatively small starting currents, these wound-rotor motors are very high-maintenance.

The converter 18 must generate a high current for such a high starting torque. At the same time, a high voltage is required from the converter 18 for the rated speed required during operation. In the case of a converter 18, the costs are essentially determined by the power. A converter 18 that is suitable both for the high current for generating a high torque for removing the sedimented charge 20 and for the high voltage for operating the mill 6 at rated speed is therefore very expensive.

FIG. 2 schematically illustrates a first embodiment of a mill arrangement 2. As shown in FIG. 1, a motor 16 of a drive unit 4 is mechanically connected to a mill 6, wherein a gearing 8 can be provided between motor 16 and mill 6. The motor 16 can be connected to a first supply 21. The first supply 21 is designed as a medium-voltage supply 22 in order to be able to provided sufficient power for the mill arrangement 2. The connection to the medium-voltage supply 22 is via a main power switch 23. The medium-voltage supply 22 has a supply voltage in the range up to 15,000 volts. During grinding operation, the motor 16 is operated directly from the medium-voltage supply 22 at a constant rated frequency 24.

If the material 20 to be ground has solidified in the mill 6, an increased torque compared to normal milling operation, and therefore a higher current, is required to remove such a sedimentation of the material 20. The motor 16 of the mill 6 is therefore fed by a first converter 25 which is implemented as a low-voltage converter 26. However, the maximum output voltage of the low-voltage converter 26 is no more than 50% of the supply voltage of the medium voltage supply 22. In particular, the maximum output voltage of the low-voltage converter 26 is up to 1000 volts.

The maximum output frequency 28 of the low-voltage converter 26 is max. 30% of the rated frequency 24. The first converter 25 implemented as a low-voltage converter 26 is operated from a second supply 30 which is implemented as a low-voltage supply 31 having a voltage up to 1000 volts. The connection to the low-voltage supply 31 is established using a main switch 23.

After removal of the sedimentation, the motor 16 is disconnected from the first converter 25 via a first switch 33 implemented e.g. as an MV disconnecter, and, in a further step, connected to the first supply 21. The drive unit 4 comprises a control device 35 which controls the switching operations and the first converter 25.

The control device 35 also allows the motor 16 not to be connected to the first supply 22 but left connected to the converter 27 for occasional low-speed operation.

FIG. 3 schematically illustrates a second embodiment of a mill arrangement 2 which, in comparison with the mill arrangement 2 in FIG. 2, additionally has a second converter 37 which is implemented as a medium-voltage converter 38. The medium-voltage converter 38 can be connected to the medium-voltage supply 22 via a main switch 23. The medium-voltage converter 38 can be connected to the motor 16 via a second switch 40. The maximum output voltage of the medium-voltage converter 38 essentially corresponds to the supply voltage of the medium-voltage supply 22.

As shown in FIG. 2, the low-voltage converter 26, which can be fed from the low-voltage supply 31, is used to dislodge a sedimented charge in the mill 6. After removal of the sedimentation, the motor 16 in FIG. 3 is connected to the medium-voltage converter 38 which increases its output voltage, preferably continuously, and synchronizes the motor 16 with the medium-voltage supply 22. In particular, the phase and/or frequency of the output voltage is matched to the medium-voltage supply 22 by the medium-voltage converter 38. The control device 35 controls the switching operations and the two converters 25, 37. The mill arrangement 2 is otherwise as shown in FIG. 2.

The controller 35 also allows the motor 16 not to be synchronized with the first supply 22 but to remain connected to the second converter 37 for operation with the variable-speed option.

The control device 35 also allows the motor 16 to be occasionally connected to the first converter 25 for low-speed operation.

FIG. 4 schematically illustrates a third embodiment of a mill arrangement 2 having, by way of example, three motors 16 each assigned to a mill 6 and driving same. The three motors 16 are controlled by the converters 25, 37 in a time-offset manner via switches 42, 43, 44. Each motor 16 is first connected to the first converter 25 and then to the second converter 37 in order, as described above, to remove any sedimentation and synchronize the respective motor 16 to the medium-voltage supply 22 with the option of leaving a motor 16 connected to the second converter 37.

1.-15. (canceled)

16. A method for controlling a motor for starting a mill containing material to be ground, said method comprising:
feeding the motor by a first converter to remove any sedimentation of the material to be ground in the mill;
disconnecting the motor from the first converter; and
connecting the motor to a first supply having a first supply voltage, wherein a maximum output voltage of the first converter is lower than the first supply voltage.

17. The method of claim 16, wherein the maximum output voltage of the first converter is defined as max. 50% of the first supply voltage of the first supply.

18. The method of claim 16, further comprising operating the motor at a constant rated frequency while connected to the first supply, with the rated frequency being greater than a maximum output frequency of the first converter.

19. The method of claim 18, wherein the maximum output frequency of the first converter is defined as max. 30% of the rated frequency of the first supply.

20. The method of claim 16, further comprising operating the first converter from a second supply providing a second supply voltage.

21. The method of claim 16, further comprising connecting the motor to a second converter, after disconnecting the motor from the first converter and prior to connecting the motor to the first supply, with the second converter having a maximum output voltage which corresponds to the first supply voltage.

22. The method of claim 21, further comprising synchronizing the motor with the first supply by the second converter.

23. The method of claim 16, further comprising:
operably connecting at least one further motor to a further mill; and
connecting the motor and the further motor in a time-offset manner at least to the first converter.

24. The method of claim 16, wherein the first converter is a low-voltage converter.

25. The method of claim 24, further comprising operating the low-voltage converter from a low-voltage supply.

26. The method of claim 16, wherein the first supply is a medium-voltage supply.

27. The method of claim 21, wherein the second converter is a medium-voltage converter.

28. A control device for controlling a motor for starting a mill containing material to be ground, said control device being configured to:
feed the motor by a first converter to remove any sedimentation of the material to be ground in the mill;
disconnect the motor from the first converter; and
connect the motor to a first supply having a first supply voltage,
wherein a maximum output voltage of the first converter is lower than the first supply voltage.

29. A drive unit, comprising a control device as claimed in claim 28.

30. A mill arrangement, comprising:
a mill containing material to be ground;
a first converter having a maximum output voltage;
a first supply having a first supply voltage; and
a drive unit operably connected to the mill, said drive unit including a motor configured to start the mill and a control device configured to feed the motor by the first converter to remove any sedimentation of material to be ground, to disconnect the motor from the first converter, and to connect the motor to the first supply, wherein the maximum output voltage of the first converter is lower than the first supply voltage.

31. The mill arrangement of claim 30, wherein the maximum output voltage of the first converter is defined as max. 50% of the first supply voltage of the first supply.

32. The mill arrangement of claim 30, further comprising a second supply providing a second supply voltage for operating the first converter.

33. The mill arrangement of claim 30, wherein the first converter is a low-voltage converter.

34. The mill arrangement of claim 30, wherein the first supply is a medium-voltage supply.

35. The mill arrangement of claim 30, further comprising a second converter, said motor being connected to the second converter, after disconnecting the motor from the first converter and prior to connecting the motor to the first supply, with the second converter having a maximum output voltage which corresponds to the first supply voltage.
